(19) United States
(12) Patent Application Publication
(10) Pub. No.: US 2026/0225111 A1
(43) Pub. Date: Aug. 6, 2026

(54) METHOD FOR RESOURCE RECOVERY FROM A BAUXITE RESIDUE

(71) Applicant: ERMAFA ENVIRONMENTAL TECHNOLOGIES GMBH, Wien (AT)

(72) Inventor: Wolfgang KAPAUN, Wien (AT)

(21) Appl. No.: 19/160,219

(22) PCT Filed: Feb. 27, 2024
(86) PCT No.: PCT/EP2024/054901

§ 371 Date: Aug. 27, 2025

(30) Foreign Application Priority Data
Feb. 28, 2023 (EP) 23158969.8

(51) Int. Cl. B03D 3/06; C01B 33/20; C22B 1/24; C22B 3/22; C22B 3/44

(52) U.S. Cl. CPC B03D 3/06; C01B 33/20; C22B 1/24; C22B 3/22; C22B 3/44

(57) ABSTRACT

A method for resource recovery from a bauxite residue, the method including the following steps: a) providing an aqueous suspension of the bauxite residue; b) adjusting a pH of the aqueous suspension to a value between 7.2 and 12.2; c) at least partial deagglomerating of suspended mineral agglomerates of the bauxite residue; and d) separating the resulting mixture into an iron-rich fraction and at least one further, preferably silicate-rich fraction, wherein at least one flocculant is added to the aqueous suspension, wherein the at least one flocculant includes starch.

The present invention relates to a method for resource recovery from a bauxite residue.

Aluminium is extracted on a large scale from bauxite using the Bayer method. Bauxite typically contains only 30 to 60% alumina, the rest is a mixture that contains iron oxides and silicates, among other things. Within the framework of the Bayer method, sufficiently pure aluminium oxide is separated from bauxite.

In a conventional Bayer method, the bauxite is finely ground and mixed with sodium hydroxide solution. This mixture is stirred in autoclaves under pressure and at high temperatures, causing the sodium hydroxide solution to dissolve the alumina from the bauxite by combining with it to form sodium aluminate. The undissolved bauxite components form the so-called bauxite residue. The bauxite residue is separated and the alumina can be further processed by stirring, calcining and other steps to obtain pure aluminium.

The bauxite residue (also known as “BR”) produced in the Bayer method is also referred to as “red mud”. This name comes from the red colour caused by the iron compounds. The bauxite residue is an enormous disposal problem. According to some sources, around 150 million tonnes of bauxite residue are produced as a waste product worldwide every year. The bauxite residue is often stored in large landfills or “red mud basins”, but in some countries it is also simply discharged into the rivers. The bauxite residue represents an environmental problem of extraordinary magnitude.

There is therefore an effort to convert the bauxite residue, which has hitherto been regarded as a waste product, into usable materials. The aim is in particular to separate the iron components, which can make up a large proportion of the bauxite residue.

A current overview of the processing of red mud in the prior art is provided by Yancun Qi (“The neutralization and recycling of red mud—a review.” Journal of physics: conference series. Vol. 1759. No. 1. IOP Publishing, 2021; DOI 10.1088/1742-6596/1759/1/012004).

Furthermore, patent specification U.S. Pat. No. 3,127,239 A discloses a method for separating the alkali-insoluble components from aluminous ores of the bauxite type from alkaline bauxite digestion lye in which they are suspended. A flocculant comprising homogenized gelatinized starch is added.

Patent specification DE 702 397 C describes a method for the treatment of red muds which are formed from bauxite during alumina production. The treatment of the red mud takes place in the cold with dilute acids with or without the addition of a neutral salt.

CN 113 857 209 A also discloses a method for recycling red mud based on an acid treatment.

A further method for resource recovery from a bauxite residue, in particular for separating iron-containing components, is known from EP 2 836 462 B1. The wet-chemical separation of at least part of the iron-containing components of the bauxite residue is to be made possible by a method which comprises the following steps: providing an aqueous suspension of the bauxite residue; adjusting a pH of the suspension to a value between 7.2 and 12.2 and adding at least one dispersant; at least partial deagglomerating of suspended mineral agglomerates of the bauxite residue by generating cavitation; and separating the resulting mixture into an iron-rich fraction and at least one further, preferably silicate-rich fraction.

Despite these and other methods known in the prior art, the problem of resource recovery from bauxite residue has not yet been satisfactorily solved. There is also a need for better methods which, for example, enable a higher yield, a higher efficiency and/or a higher throughput. In particular, there is also a need for cheaper and more environmentally friendly methods that can be carried out on as large a scale as possible.

It is an object of the present invention to provide such methods.

The invention therefore relates to a method for resource recovery from a bauxite residue, the method comprising the following steps:
a) providing an aqueous suspension of the bauxite residue;
b) adjusting a pH of the aqueous suspension to a value between 7.2 and 12.2;
c) at least partial deagglomerating of suspended mineral agglomerates of the bauxite residue; and
d) separating the resulting mixture into an iron-rich fraction and at least one further, preferably silicate-rich fraction,
wherein at least one flocculant is preferably added to the aqueous suspension, wherein the at least one flocculant comprises starch.

The mineral agglomerates contained in the bauxite residue are agglomerated particles, which preferably comprise, among other things, iron oxides and silicates. The particles are usually connected to each other by electrostatic and steric bonding forces. In the method disclosed in EP 2 836 462B1, the binding forces between the agglomerated mineral components are to be at least partially eliminated in order to enable deagglomeration. For this purpose, the surface charges of the mineral particles should be compensated as much as possible by adjusting the pH value in the region of the isoelectric point or the point of zero charge (PZC). According to EP 2 836 462 B1, it is further provided that a dispersant is added to the suspension, which is intended to stabilize or maintain the particle insulation achieved by the deagglomeration. This is intended to prevent once released particles from reagglomerating with undesirable other particles and to support deagglomeration. The deagglomeration should then take place by generating cavitation, i.e. by forming and dissolving steam-filled cavities (steam bubbles) in the suspension agent of the bauxite residue, e.g. by means of a dissolver stirrer or by admission with ultrasound. Subsequently, an iron-rich fraction and a silicate-rich fraction are to be separated.

EP 2 836 462 B1 indicates that no additional auxiliaries such as flocculants or the like are required. This is fundamentally advantageous, since flocculants can often be environmentally problematic and sometimes also expensive substances.

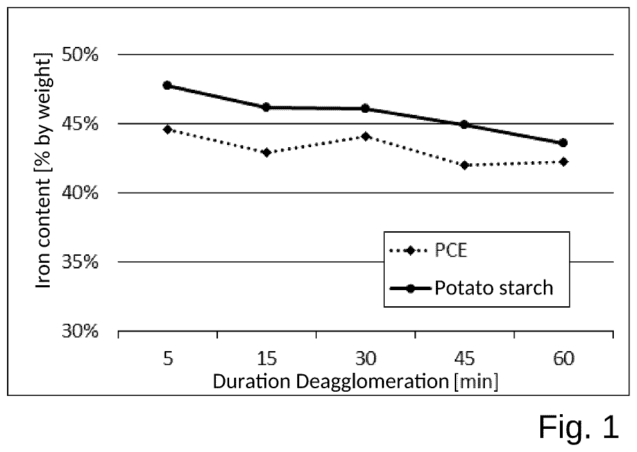

In the context of the present invention, however, it has now surprisingly been found that starch—which is neither expensive nor harmful to the environment—may be used as a flocculant and that a considerable improvement in the process can still be achieved. Without being bound by any theory, the inventors suspect that the flocculant makes it possible to capture and agglomerate the iron particles in the suspension more quickly and/or more pure. The agglomerated iron particles can then be separated in the form of the iron-rich fraction. Starch is not only cheap and available in large amounts, but also does not pollute the environment. In addition, it has been found, completely surprisingly, that starch functions surprisingly well as a flocculant in the context of the method according to the invention and even leads to better results than conventional chemical flocculants, such as the environmentally much more problematic polycarboxylate ester (PCE). The use of PCE is widespread, but due to its harmfulness to aquatic organisms, it must not enter sewers or surface waters. In the context of the invention, it has now been shown that starch can not only replace PCE as a flocculant on an equivalent basis, but also provides even better results. Thus, with potato starch, it was possible to achieve an iron content in the iron-rich fraction that was about 3 percentage points higher than with PCE—this corresponds to a relative increase of about 7 percent (cf. Example 2 and FIG. 1). In view of the enormous amounts of bauxite residue to be treated and the large scales in which such a method is to be carried out, such an increase represents a verifiable leap, which has a significant impact on the economics of the method. The fact that this leap can be achieved with a means that is unproblematic for the environment opens up new perspectives for the processing of bauxite residue and could be an essential step towards solving this major environmental problem.

Irrespective of the use of starch as a flocculant, a further surprising improvement of the method according to EP 2 836 462 B1 has emerged within the scope of the invention. Thus, it has unexpectedly been shown that even without the use of starch as a flocculant, it is advantageous to carry out the deagglomeration of the suspended mineral particles of the bauxite residue without cavitation. Comparative experiments have shown that a deagglomeration with an inline disperser, which does not cause cavitation, leads to a higher iron content in the iron-rich fraction than if the deagglomeration with cavitation is carried out by a toothed disc system (cf. Example 4). In addition and independently of this, an inline disperser also makes it possible to shorten the dispersing time, as a result of which—likewise unexpectedly—an even higher iron content can be achieved. At the same time, this makes it possible to significantly increase the total time of the process as well as the throughput.

Finally, it has been found that in the process according to the invention—i.e. using starch as flocculant and/or in the case of deagglomeration with an inline disperser—the dispersant provided in EP 2 836 462 B1, which is to be added to the bauxite residue suspension, can be completely dispensed with. This in turn increases the economic efficiency of the process and at the same time reduces the environmental impact that may be associated with environmentally problematic dispersants.

Apart from the differences mentioned above, the method according to the invention can be carried out as described in EP 2 836 462 B1. The content of EP 2 836 462 B1 is therefore hereby incorporated into the present application. In particular, the steps a) providing an aqueous suspension of the bauxite residue; b) adjusting a pH of the suspension to a value between 7.2 and 12.2; c) at least partial deagglomerating of suspended mineral agglomerates of the bauxite residue; and d) separating the resulting mixture into an iron-rich fraction and at least one further, preferably silicate-rich fraction; can be carried out as described in EP 2 836 462 B1.

In connection with the invention, the bauxite residue is preferably obtainable or obtained by the Bayer method. This may be bauxite residue from a landfill. In this way, existing landfills can be dismantled and recycled. However, the bauxite residue may also come directly from a Bayer method. The method according to the invention can therefore be carried out immediately after the Bayer method, wherein in step a) of the method the bauxite residue obtained in the Bayer method is mixed with water in order to provide the aqueous suspension of the bauxite residue.

The method according to the invention comprises steps a) to d) as described above. Preferably, the steps of the method are carried out in the order indicated. In a preferred embodiment, the method consists of steps a) to d).

In step a) of the method according to the invention, the bauxite residue can be mixed with water to obtain the aqueous suspension of the bauxite residue. Preferably, the bauxite residue is homogenized with water.

Homogenization may take place in a homogenizing container. The homogenizing container is preferably heatable, for example via a double jacket. An agitator may be used for homogenization. Homogenization may also take place via an inline disperser. For homogenization, the suspension can circulate between the inline disperser and the homogenizing container, wherein the inline disperser can have the possibility of switching over and pumping the suspension into the next process step.

The homogenizing container is preferably an open container. Water for dilution may be fed into the homogenizing container, preferably also process water, which is separated from the silicate-rich fraction. Bauxite residue can be added from a volumetric container with stirring (or in the case of an inline disperser with constant circulating pumping).

The aqueous suspension of the bauxite residue is adjusted to a pH between 7.2 and 12.2 in step b).

Preferably, the pH is adjusted in step b) by adding an acid. Citric acid is particularly preferred. Among other things, citric acid has the advantage that it is environmentally unproblematic.

In a preferred embodiment, the acid, in particular the citric acid, is added in an amount in the range from 0.25 to 2% by weight, based on the dry matter content of the aqueous suspension.

The acid may advantageously be added in liquid form from a storage container via a metering pump. The amount of acid added can be ensured by pH measurements of the suspension.

It has been found to be advantageous if, in step b), the temperature of the suspension is also adjusted to a specific range. It is particularly advantageous if the temperature is adjusted to a value between 20° C. and 90° C., preferably between 30° C. and 70° C.

The residence time of the bauxite residue in the homogenizing container may preferably be 10 to 120 minutes, preferably 15 to 90 minutes, more preferably 20 to 70 minutes. Before the deagglomeration in step c), the suspension is preferably kept in the pH range and/or temperature range specified above for the specified time duration, in particular 20 to 70 minutes. This residence time supports in particular the hydration of the individual mineral components, so that the individual particles are surrounded by a regular hydrate shell.

From the homogenizing container, the suspension can be transferred to at least one dispersing container, in which the deagglomeration can take place. Typically, deagglomeration takes place through the input of mechanical energy to separate the agglomerated particles into microscopic individual particles. The mutual attractive forces can advantageously be minimized by adjusting the pH value and then overcome by mechanical energy. After deagglomeration, the individual minerals can be present in the suspension largely separated from each other. The aim of deagglomeration is, in simple terms, that each individual mineral particle occurring in the mixture floats separately in the aqueous phase.

The pH value can be adjusted again in the dispersing container (in addition or as an alternative to the adjustment already made in the homogenising container).

As mentioned above, it is preferred in the context of the method according to the invention if the deagglomeration in step c) takes place without prior addition of a dispersant. Among other things, this increases the economic efficiency of the process and at the same time reduces the environmental impact that environmentally problematic dispersants can otherwise cause.

Step c) comprises at least partially deagglomerating suspended mineral agglomerates in the aqueous suspension. The deagglomeration preferably takes place by subjecting the mineral agglomerates to high shear forces. This can be done by cavitation, e.g. with the help of stirrers running at high speeds, which are specially shaped to achieve cavitation. For example, a toothed disc system may be used.

However, it is preferred if the deagglomeration in step c) takes place without generating cavitation. As mentioned above, it has surprisingly been shown that the iron content of the iron-rich fraction can be further increased if the deagglomeration takes place without cavitation (cf. Example 4).

The use of a rotor-stator system, in particular an inline disperser, has proven to be particularly suitable for the method according to the invention. On the one hand, an inline disperser has the advantage that no cavitation is generated. On the other hand, it has the further advantage that it enables a faster and possibly also continuous process. As a result, the dispersion time can be shortened, as a result of which—likewise expected—an even higher iron content can be achieved in the iron-rich fraction (cf. Example 2 and FIG. 1). At the same time, the total time of the method is also shortened and the throughput increased. Within the scope of the invention, it is therefore preferred if the deagglomeration in step c) takes place with an inline disperser.

Surprisingly, it has been found to be advantageous if the deagglomeration in step c) takes place for a total duration of less than 120 minutes, preferably less than 90 minutes, more preferably less than 60 minutes, more preferably less than 45 minutes, more preferably less than 30 minutes, more preferably less than 20 minutes. Within the scope of the invention, it has been shown that such a short total duration can lead to an even higher iron content in the iron-rich fraction obtained (cf. Example 2 and FIG. 1). It is therefore preferred if the deagglomeration in step c) takes place for a total duration in the range of 1 to 120 minutes, preferably 2 to 90 minutes, more preferably 3 to 60 minutes, more preferably 5 to 45 minutes, more preferably 7 to 30 minutes, more preferably 10 to 20 minutes.

Preferably, at least one flocculant is added to the aqueous suspension, preferably to support an agglomeration of iron-containing particles. The flocculant may be added after the deagglomeration is complete, i.e., after completion of step c). Alternatively, however, the flocculant can also be added beforehand, e.g. during the deagglomeration or even before the deagglomeration, i.e. for example between steps a) and b) or between steps b) and c). The addition preferably takes place before step d), preferably between steps c) and d).

The aim in this step is to get the individual particles to adhere as much as possible to similar particles and to form an agglomerate together, which can be sedimented and can be separated from the suspension by gravity, for example, due to the density difference of the particles in time sequence. Simply put, the iron particles should be trapped in the suspension and agglomerated. The flocculant is preferably added in an amount in the range from 0.05 to 0.40% by weight based on the dry matter content of the aqueous suspension.

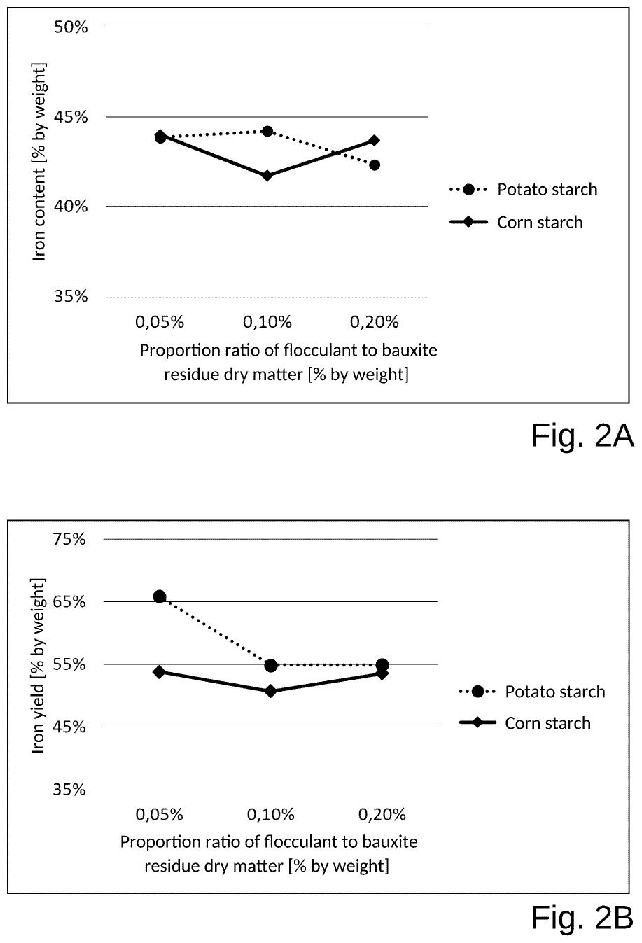

As mentioned above, starch has proven to be a particularly beneficial flocculant. It was thus possible to achieve a considerable improvement in the process and even a higher iron content in the iron-rich fraction than when using significantly more environmentally harmful flocculants such as PCE (cf. Example 2 and FIG. 1). Preferably, the at least one flocculant is therefore starch. Any type of starch may be used within the scope of the invention. However, potato starch has been shown to have certain special advantages. An excellent iron content in the iron-rich fraction was achieved with both potato and corn starch. However, it was found that the iron yield—i.e. the ratio between the amount of iron in the iron-rich fraction and the total amount of iron in the starting product bauxite residue—was even higher when potato starch was used than when corn starch was used (cf. Example 3 and FIG. 2B). Potato starch is therefore particularly preferred within the scope of the invention.

In addition, and regardless of the type of starch used, it has proven to be highly advantageous to use activated starch as a flocculant. This is preferably acid-activated starch—i.e. the starch is activated by treatment with an acid. Activated starch has been shown to further improve iron content and yield. Without being bound to a theory, the inventors suspect that the activation leads to a better unfolding of the starch and even better storage on the particles and accelerates agglomeration.

The starch may be activated with any type of acid, for example HCl. However, it has proven to be particularly advantageous to use citric acid for the activation of the starch. This is particularly preferred if the same acid has already been used in step b) for adjusting the pH value, since no additional substances are introduced into the method in this way. For activation, the starch may be kept, for example, for at least 1 hour in citric acid (e.g. 5% by weight in water) at at least 50° C.

The flocculant, in particular the activated potato starch, can be added in liquid form from a storage container via a metering pump.

In step d) of the method, the mixture is finally separated into an iron-rich fraction and at least one further, preferably silicate-rich fraction.

Separation into these two fractions may take place based on a different specific gravity, wherein the iron-rich fraction has a lower specific gravity than the silicate-rich fraction. Preferably, the separating in step d) takes place by selective sedimentation, preferably in a sedimentation basin. The addition of flocculant can also take place in the sedimentation basin. After the deagglomeration in step c), the suspension can be passed from the dispersing container into the sedimentation basin. In this basin, an agglomeration of similar particles can then take place and, among other things, larger units of iron oxide agglomerates can form, which sink due to the higher specific gravity. At the bottom of the sedimentation basin, the settling iron oxide can be compacted and continuously discharged via rotary valves or screw conveyors. The further, preferably silicate-rich fraction can be discharged at the overflow of the sedimentation basin.

The iron-rich fraction may also be referred to as a “heavy fraction,” an “iron oxide concentrate,” or a “concentrate of iron minerals.” This fraction is usually the fraction with the highest density. It preferably contains iron minerals, in particular iron oxide and iron hydroxide. It separates from the suspension first and can, for example, be discharged from the separator after compression by vibration. The iron-rich fraction can finally be used for recycling in iron production and thus forms a valuable raw material.

The further, preferably silicate-rich fraction may also be referred to as a “light fraction”. This can be an iron-depleted fraction containing clay minerals.

In a preferred embodiment, the further, preferably silicate-rich fraction obtained in step d) is fed to a solid-liquid separation, preferably by filtration and/or centrifugation, in order to separate process water.

Calcium hydroxide can be added to the further, preferably silicate-rich fraction before the solid-liquid separation. This can improve the separation or filtration properties.

In a preferred embodiment, the process water separated from the further, preferably silicate-rich fraction is recycled into the suspension in step a). It can be fed into a homogenising container and used in the homogenisation of fresh bauxite residue.

All percentages (%) herein refer, unless otherwise indicated, to percentages by weight (% by weight).

The present invention is illustrated by the following examples and figures, to which, of course, it is not limited.

FIG. 1: Comparison between starch and PCE as flocculant. The results are shown for different time durations of deagglomeration.

FIG. 2: Comparison between potato starch and corn starch as flocculant. (A) Iron content in the sediment. (B) Iron yield in sediment.

### EXAMPLE 1—GENERAL PROCESS DESCRIPTION

In the following, an exemplary embodiment of the method according to the invention is described, as it was also used in the comparative experiments in the following examples.

### Materials Used

Bauxite residue (red mud)
Citric acid (solid, as anhydrite)
Tap water
Flocculant: Polycarboxylate ether (PCE), potato starch or corn starch

### Process Flow

The bauxite residue was slurried with water and stirred with a toothed disc system or with an inline disperser. The suspension was heated to 50° C. and the pH was adjusted to 9.6 by adding citric acid.

The flocculant has been prepared. In the case of PCE, it was simply mixed with water. Starch was activated with 5% by weight citric acid in water for at least 1 hour at at least 50° C. The flocculant was then added to the suspension and the rotation speed was increased to crush the particles. When using the toothed disc system, cavitation was thereby generated. No cavitation occurred when using the inline disperser.

For sedimentation, the comminuted particles were allowed to settle. Iron-containing particles settled faster due to the higher specific gravity. By decanting, the heavy fraction was separated from the light fraction.

The samples were analyzed by SEM and examined for their elemental composition. In particular, the iron content in the heavy (iron-rich) fraction was determined.

### EXAMPLE 2: COMPARING STARCH VS PCE

Two series of tests were carried out, one with PCE and one with potato starch as flocculant. The duration of the deagglomeration was varied. The experiments were carried out with inline dispersers as described in Example 1.

The results are shown in FIG. 1. There was a significant increase in the iron content in the iron-rich fraction due to the use of starch as a flocculant compared to PCE.

In addition, the results showed that the shorter the total duration of the deagglomeration, the higher the iron content achieved in the iron-rich fraction.

### EXAMPLE 3: COMPARISON OF POTATO STARCH VS CORN STARCH

To compare potato starch and corn starch as flocculant, experiments were carried out with a toothed disc as described in Example 1. The starches were used in amounts of 0.05% by weight, 0.10% by weight and 0.20% by weight, in each case based on the dry matter of the bauxite residue. The iron content achieved in the iron-rich fraction and the total yield were determined. To determine the yield, the total amount of iron present in the bauxite residue used was calculated and compared with the amount of iron obtained at the end in the iron-rich fraction.

The iron content is shown in FIG. 2A. Potato and corn starch led to comparably good results.

The iron yield achieved is shown in FIG. 2B. This showed a clear advantage of potato starch over corn starch. For each of the three addition quantities tested, a higher yield was achieved with potato starch than with corn starch. The difference was particularly clear at 0.05% by weight of starch, where the (very good) yield of 53.8% was achieved for corn starch, but the even significantly better yield of 65.8% was achieved for potato starch.

### EXAMPLE 4: COMPARISON OF DEAGGLOMERATION WITH VS WITHOUT CAVITATION

In order to investigate the influence of cavitation during deagglomeration, experiments were carried out once with a toothed disc system (generates cavitation) and once with an inline disperser (does not generate cavitation) as described in Example 1. PCE was used as flocculant.

The essential difference between the two methods is the type of energy input. While in the case of the toothed disc, the dispersion is brought about with the help of cavitation effects, the inline disperser uses a rotor-stator mixer, which breaks and disintegrates the grains over a narrow gap with strong crushing and transverse forces.

Two experiments were carried out with each of the two dispersing methods. The following results were obtained for the iron content in the iron-rich fraction:
With cavitation (toothed disc) a mean iron content of 44.2% by weight was achieved (individual values: 45.3% by weight and 43.1% by weight).
Without cavitation (inline disperser) a mean iron content of 46% by weight was achieved (individual values: 45.0% by weight, 47.0% by weight).

1. A method for resource recovery from a bauxite residue, the method comprising the following steps:
a) providing an aqueous suspension of the bauxite residue;
b) adjusting a pH of the aqueous suspension to a value between 7.2 and 12.2;
c) at least partial deagglomerating of suspended mineral agglomerates of the bauxite residue; and
d) separating the resulting mixture into an iron-rich fraction and at least one further, preferably silicate-rich fraction,
wherein at least one flocculant is added to the aqueous suspension, wherein the at least one flocculant comprises starch.

2. The method according to claim 1, wherein the pH in step b) is adjusted by adding citric acid.

3. The method according to claim 1, wherein the acid is added in an amount ranging from 0.25 to 2% by weight based on the dry matter content of the aqueous suspension.

4. The method according to claim 1, wherein in step b), the temperature of the suspension is adjusted to a value between 30° C. and 70° C.

5. The method according to claim 1, wherein the deagglomerating in step c) takes place without prior addition of a dispersant.

6. The method according to claim 1, wherein the deagglomerating in step c) takes place without generating cavitation.

7. The method according to claim 1, wherein the deagglomerating in step c) takes place with an inline disperser.

8. The method according to claim 1, wherein the deagglomerating in step c) takes place for a total duration of less than 45 minutes.

9. The method according to claim 1, wherein the flocculant is added in an amount ranging from 0.05 to 0.40% by weight based on the dry matter content of the aqueous suspension.

10. The method according to claim 1, wherein the starch is potato starch.

11. The method according claim 1, wherein the starch is an activated starch.

12. The method according to claim 1, wherein the separating in step d) takes place by selective sedimentation.

13. The method according to claim 1, wherein the further, preferably silicate-rich fraction obtained in step d) is fed to a solid-liquid separation in order to separate process water.

14. The method according to claim 1, wherein calcium hydroxide is added to the further, preferably silicate-rich fraction prior to the solid-liquid separation.

15. The method according to claim 1, wherein the process water separated from the further, preferably silicate-rich fraction is recycled into the suspension in step a).
